(19) United States
(12) Patent Application Publication
(10) Pub. No.: US 2024/0273106 A1
(43) Pub. Date: Aug. 15, 2024

(54) RAW DATA AUGMENTATION FOR FEATURE SETS

(71) Applicant: International Business Machines Corporation, Armonk, NY (US)

(72) Inventor: William Karol Lynch, Rathkeale (IR)

(21) Appl. No.: 18/167,933

(22) Filed: Feb. 13, 2023

(51) Int. Cl. G06F 16/2457; G06F 16/21; G06N 5/022

(52) U.S. Cl. CPC G06F 16/24578; G06F 16/211; G06N 5/022

(57) ABSTRACT

Aspects of the invention include techniques for augmenting a feature set with additional raw data. A non-limiting example method includes receiving an input that includes a feature set. The feature set includes a plurality of features. The method includes querying, using the input, a formula index. The formula index includes a plurality of formulas and a plurality of identifiers. One or more identifiers are mapped in the formula index to each respective formula of the plurality of formulas. The method includes, responsive to the querying, returning an output having one or more additional features for the input.

### BACKGROUND

The present invention generally relates to artificial intelligence and machine learning, and more specifically, to computer systems, computer-implemented methods, and computer program products for augmenting a feature set with additional raw data.

Artificial intelligence (AI) refers to the capacity for machines, based on learned information, to make appropriate decisions and/or to provide appropriate outputs in response to an input, such as a prompt or query. More specifically, AI is able to learn from a data set to solve problems and provide relevant recommendations. AI is a subset of cognitive computing, which refers to systems that learn at scale, reason with purpose, and naturally interact with humans.

Machine learning, a subset of AI, utilizes algorithms to learn from data (e.g., training data sets) to create foresights based on this data, such as, for example, a trained model that provides an output in response to an input. More specifically, machine learning models are data files used by hardware and/or software entities or by hardware and/or software systems which run a dedicated software, with the purpose to produce a specific kind of output when an input having a predetermined format is provided. Machine learning models are generally defined as composed of different stages, the entirety of the stages being called a pipeline. Two different machine learning models differ in the definition of at least one of these stages.

### SUMMARY

Embodiments of the present invention are directed to techniques for augmenting a feature set with additional raw data. A non-limiting example method includes receiving an input that includes a feature set. The feature set includes a plurality of features. The method includes querying, using the input, a formula index. The formula index includes a plurality of formulas and a plurality of identifiers. One or more identifiers are mapped in the formula index to each respective formula of the plurality of formulas. The method includes, responsive to the querying, returning an output having one or more additional features for the input.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments of the present invention;

FIG. 2 depicts a block flow diagram for raw data augmentation in accordance with one or more embodiments of the present invention;

FIG. 3 depicts another block flow diagram for raw data augmentation in accordance with one or more embodiments of the present invention;

FIG. 4 depicts yet another block flow diagram for raw data augmentation in accordance with one or more embodiments of the present invention;

FIG. 5 is a flowchart in accordance with one or more embodiments of the present invention; and

FIG. 6 depicts a formula graph constructed in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified.

In the accompanying figures and following detailed description of the described embodiments of the invention, the various elements illustrated in the figures are provided with two or three-digit reference numbers. With minor exceptions, the leftmost digit(s) of each reference number correspond to the figure in which its element is first illustrated.

### DETAILED DESCRIPTION

Machine learning involves training a model on input data in the form of features, to cluster related examples and/or to predict target variables. Many different features may be required to build an effective model for a machine learning task. If key features are absent from the input data, then no matter how clever the modelling approach used, a useful model for the target may not be extrapolated from the accessible data. In other words, good models require good training features. Unfortunately, it is nontrivial to identify and/or generate “good” features for a given model.

One approach to enriching a data set for machine learning is referred to as automated feature engineering, which refers to the generation of cross features by combining (in whole or in part) two or more existing features in a data set. In short, automated feature engineering relies upon various combinations of portions of the data set itself to enrich the input data. Observe that, by definition, automated feature engineering is limited in its ability to enrich data sets by the space of available cross features.

One or more embodiments of the present invention address one or more of the above-described shortcomings by providing computer-implemented methods, computing systems, and computer program products for feature set raw data augmentation. Notably, aspects of this disclosure are focused on automated data augmentation (adding more raw data) rather than automated feature engineering (generating cross features by combining aspects of existing features).

One or more embodiments of the present disclosure automatically discover relevant features for a given machine learning problem without being bound by available cross features. In some embodiments, the use of relationships between the variables in a formula (derived, e.g., from engineering, mathematics, physics, a problem domain, etc.) are leveraged to unearth new and relevant basic features (i.e., new raw data) for the respective machine learning problem. In other words, mathematical formulas themselves can be leveraged for automated data augmentation. Advantageously, machine learning models themselves are generally complex mathematical functions; thus, adding new candidate features (raw data) that have a direct mathematical relationship with a target and/or existing feature set directly improves the quality of the underlying mathematical functions, resulting in a trained model having higher accuracy (e.g., minimized loss) and breadth (e.g., range of usable inputs for which valid outputs can be generated).

While a number of automated approaches to relationship extraction have been investigated, many approaches (e.g., text, tables, knowledge graphs, etc.) have, in practice, been limited in varying degrees by the reservoir of relevant features that exist within the respective format, the difficulty in extracting relationships from that format, the false positive rate, for relationship extraction with that format (in other words, on average what fraction of the extracted features are useful), and the difficulty in extracting mathematical relationships with the target/existing feature set (machine learning models are generally complex mathematical functions and thus features that have a direct mathematical relationship with the target are especially valuable).

Data augmentation alternatives, include, for example, tables, text mining or text relation extraction, generative language models, and knowledge graphs. A tables-based approach uses the fact that two items are located within the same table as a proxy for there being a relationship between those items. This is a somewhat fuzzy approach and is more likely to generate a number of false positive candidates (i.e., feature candidates that are unlikely to improve the results). Also, for a table to exist necessarily requires data to have been collected for the entries (e.g., columns) in the table. This “collection” requirement limits the feature reservoir to features that an entity (e.g., a person, an automated machine or system) has already collected data for and to tables that contain data that the entity is willing to share. Text mining or text relation extraction involves searching for relationships within natural language text. The primary drawback is the possibility of a significant number of false positive candidates. Generative language models, a form of text processing, could be used to find objects related to the prediction target, but, like other text based approaches the primary drawback is a significant number of false positive candidates. Knowledge Graphs are based on a common structured representation for modelling semantic relationships between objects. One drawback of knowledge graphs is that, while high level and shallow general purpose knowledge graphs are available, detailed domain specific knowledge graphs are uncommon and time consuming to produce. In addition, the type of semantic relationships modelled within knowledge graphs are not necessarily easily translated to the type of mathematical or numerical relationships inherent to machine learning models.

Advantageously, leveraging mathematical formulas for automated data augmentation in accordance with one or more embodiments offers several advantages over these other techniques for identifying and/or generating input data (generally referred to as the data augmentation problem, or restated, as the problem of automatically finding features that have a relationship with the target and/or existing feature set). In particular, augmenting a feature set with raw data derived from mathematical formulas is natively free from any constraints imposed by the existing reservoir of relevant features. Moreover, false positive rates are relatively lower as, for example, the relationship between variables in an equation is more direct than the potential relationship between elements in a table.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

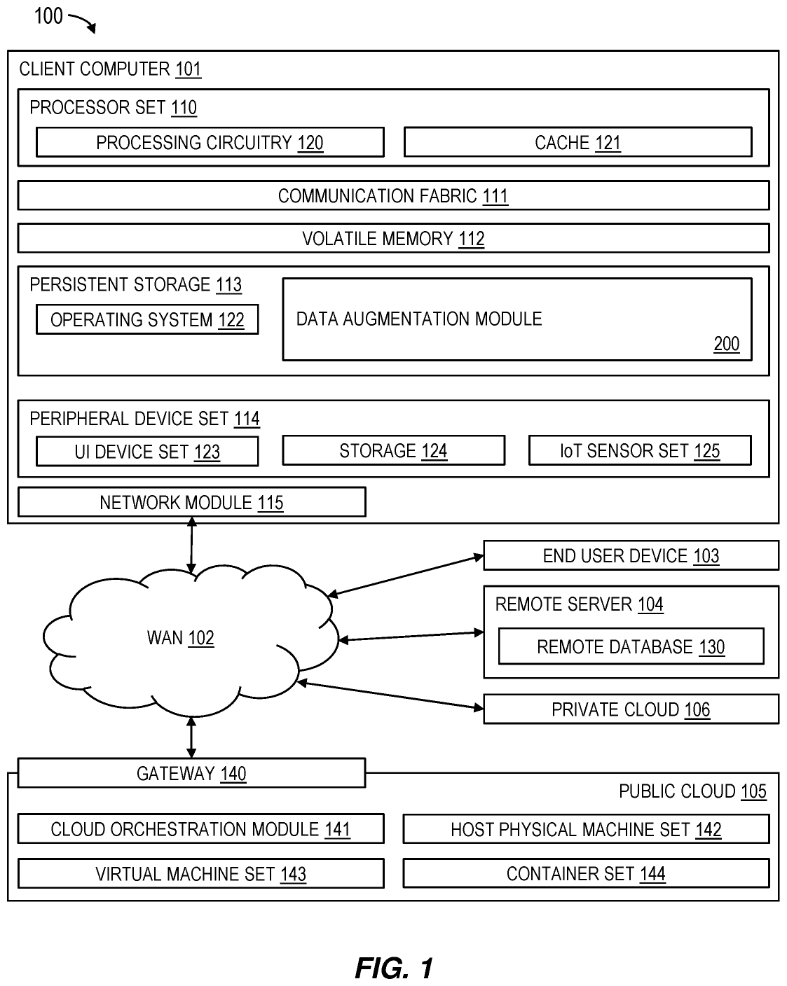

Referring now to FIG. 1, computing environment 100 contains an example of an environment for the execution of at least some of the computer code involved in performing the inventive methods, such as data augmentation module 200 (also referred to herein as block 200). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is to be understood that the block diagram of FIG. 1 is not intended to indicate that the computing environment 100 is to include all of the components shown in FIG. 1. Rather, the computing environment 100 can include any appropriate fewer or additional components not illustrated in FIG. 1 (e.g., additional memory components, embedded controllers, modules, additional network interfaces, etc.). Further, the embodiments described herein with respect to the computing environment 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

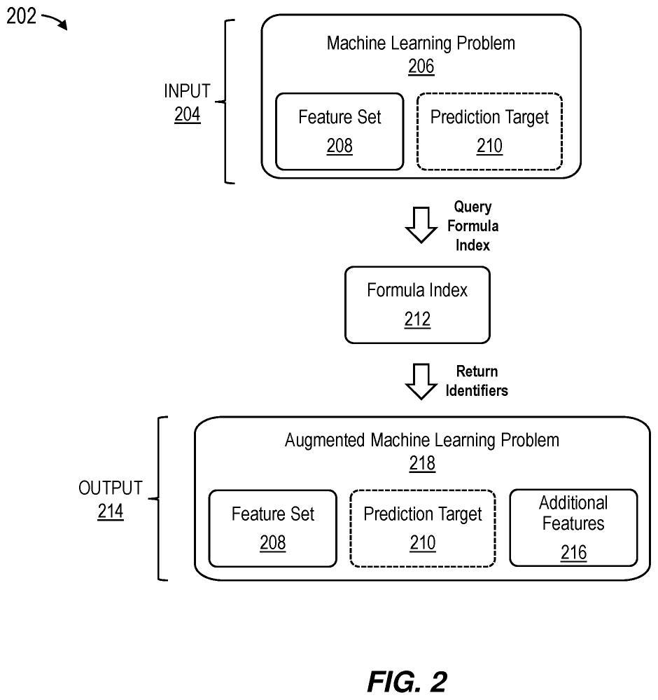

Referring now to FIG. 2, a block flow diagram 202 for raw data augmentation is shown in accordance with one or more embodiments of the present invention. In some embodiments, the block flow diagram 202 can be implemented by (in whole or in part) one or more processors (e.g., the computing environment 100 of FIG. 1). Any number of elements of the computing environment 100 of FIG. 1 may be used in and/or integrated with the block flow diagram 202. In some embodiments, the block flow diagram 202 can be implemented by (in whole or in part) the data augmentation module 200 of FIG. 1.

As shown in FIG. 2, the block flow diagram 202 can include an input 204. In some embodiments, the input 204 defines a machine learning problem 206 and includes, for example, textual descriptions and/or semantic mappings for an existing feature set 208. In some embodiments, the machine learning problem 206 further includes textual descriptions and/or semantic mappings for a prediction target 210. The feature set 208 is not meant to be particularly limited, but can include, for example, a plurality of features (e.g., measured characteristics, attributes, qualities, properties, etc.) for the respective machine learning problem 206. The prediction target 210 can denote the feature(s) of the feature set 208 for which predictions are desired (e.g., the desired output). In other words, the variable(s) that a user of the computing environment 100 would like to predict given the rest of the data set (e.g., the input 204).

In some embodiments, the feature descriptions, textual and/or semantic mappings of the input 204 is used to query a formula index 212. In some embodiments, the formula index 212 includes a database that stores formulas, as well as textual and/or semantic descriptions of the formulas and their identifiers. For example, consider Einstein's formula for mass-energy equivalence, E=mc². An example entry for Einstein's formula in the formula index 212 can include some of all of the following information:

```
{
  formula : “E=m \cdot c\hat{ }{2} ”
  description : “Formula relating mass and energy.”
  identifiers : [ { symbol : “E”,
    description: “Energy”,
    semantic mapping: “Q11379”
  },{
    symbol : “m”,
    description: “Mass”,
    semantic mapping: “Q11423”
  },{
    symbol : “c”,
    description: :“Speed of Light”,
    semantic mapping: “Q2111”
  }]
}
```

It should be understood that Einstein's formula for mass-energy equivalence is illustrative only, and that any arbitrary formula can be used to populate the formula index 212. The formula index 212 can be populated manually (accurate but labour intensive), programmatically (less accurate but removes labour overhead) or programmatically with human supervision (a hybrid approach), and all such configurations are within the contemplated scope of this disclosure.

In some embodiments, the formula index 212 is configured to return (output), in response to a query, one or more candidate identifiers. Continuing from the prior example, consider an illustrative scenario where a user tasks the formula index 212 with a machine learning problem 206 having N inputs 204. Consider further that the machine learning problem 206 is an energy problem. In some embodiments, the formula index 212 can be leveraged to find (i.e., output) one or more new candidate features (i.e., candidates for new inputs) that are not already found in the feature set 208. For example, in some embodiments, “mass” may not be provided as an original input, but, due to the formula index 212 having knowledge of Einstein's formula for mass-energy equivalence, “mass” is output as a candidate feature for solving the energy problem.

In some embodiments, querying the formula index 212 includes matching one or more existing features in the input 204 with one or more identifiers in the formula index 212, and then returning one or more other identifiers from the matched formulas that are not already found in the input 204. In other words, return identifiers that share a formula with an existing feature. For example, the existing feature “energy” can be matched to the semantic mapping identifier “Q11379” in the formula index 212, and the identifier “Q11423” for the candidate feature “mass” can be returned. The querying process is not meant to be particularly limited, and other approaches are possible. In some embodiments, for example, one or more different high-level approaches can be taken to query the formula index 212. For example, querying can include searching the formula index 212 for formulas containing an identifier that matches the prediction target 210. In some embodiments, querying can include searching the formula index 212 for formulas containing an identifier that matches a feature in the existing feature set 208. Several techniques can be used to match related identifiers, such as, for example, a keyword based search, leveraging a distributed representation with a distance measure (e.g., cosine distance), and/or matching via semantic mappings.

In some embodiments, the computing environment 100 and/or the formula index 212 is configured to return an output 214 that includes, as one or more additional features 216, the candidate identifiers. Any aspect of the identifiers can be returned, such as, for example, the symbol (e.g., “m”), description: “mass”, mapping (e.g., “Q11423”), etc., of a respective candidate. In some embodiments, the output 214 includes textual descriptions and/or semantic mappings of the respective candidate(s). The output 214 can further include the feature set 208 and/or the prediction target 210. In some embodiments, the feature set 208 and the additional features 216 are combined to define a single, augmented feature set (not separately shown). In other words, the output 214 can define an augmented machine learning problem 218 that includes more raw data than found in the input 204.

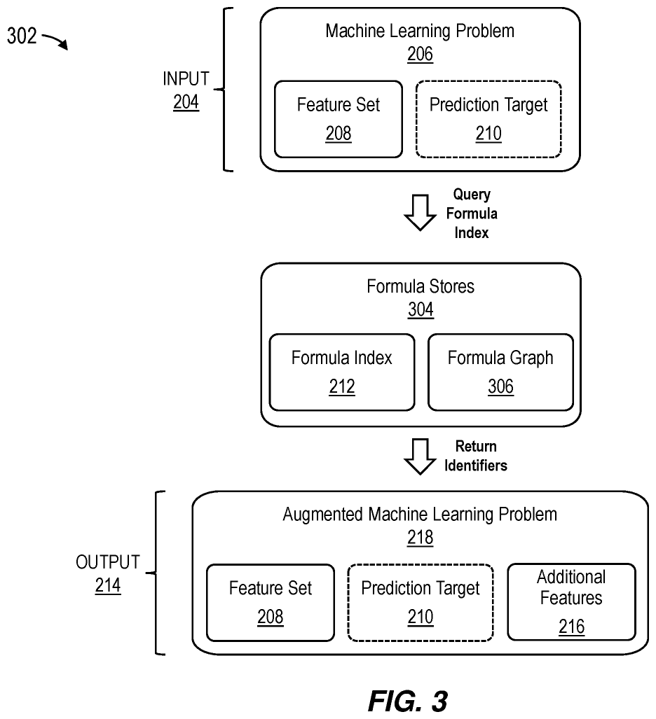

FIG. 3 depicts a block flow diagram 302 for raw data augmentation in accordance with one or more embodiments of the present invention. The block flow diagram 302 is configured in a similar manner as the block flow diagram 202 discussed with respect to FIG. 2, except that the block flow diagram 302 includes formula stores 304. In some embodiments, the formula stores 304 include the formula index 212 and a formula graph 306.

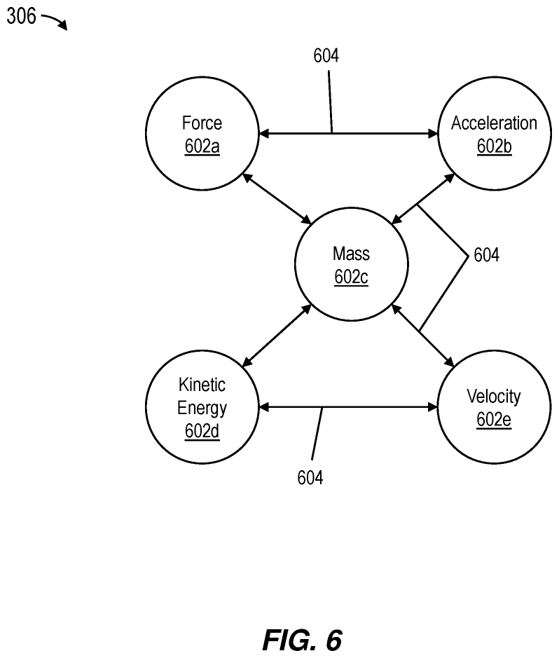

In some embodiments, the formula graph 306 includes a graph having a plurality of nodes and edges (refer to FIG. 6). In some embodiments, each node in the formula graph 306 defines a respective feature identifier, such as a description, semantic mapping, etc., extracted from the formulas in the formula index 212. In some embodiments, the formula graph 306 is constructed such that an edge exists between two respective nodes in the formula graph 306 if, and only if, their respective identifiers co-occur in the same formula.

In this framework, querying the formula stores 304 can include finding the node that best matches the prediction target 210. In some embodiments, the formula stores 304 are configured to return all N nodes with a predetermined distance measurement (e.g., Jaccard similarity, cosine similarity, Euclidean distance, etc.) from the prediction target 210. For example, the formula stores 304 can return all N nodes in the formula graph 306 at a distance of 1, 2, 3, etc., from the prediction target 210 (using, e.g., a Breadth First Search starting from the prediction target 210).

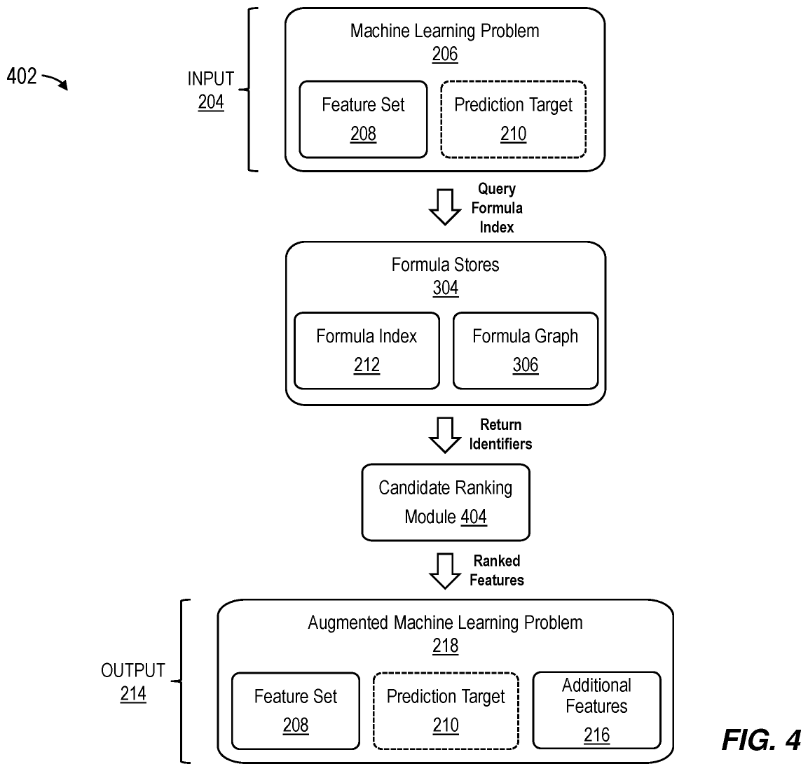

FIG. 4 depicts a block flow diagram 402 for raw data augmentation in accordance with one or more embodiments of the present invention. The block flow diagram 402 is configured in a similar manner as the block flow diagram 302 discussed with respect to FIG. 3, except that in the block flow diagram 402 the returned identifiers are ranked prior to passing the identifiers to output 214.

In some embodiments, the identifiers from the formula stores 304 are passed to a candidate ranking module 404 configured to rank the identifiers. Identifiers can be ranked based on a variety of factors, such as, for example, to minimize the financial cost associated with capturing and evaluating the respective feature(s) for usefulness against a given task. In some embodiments, a goal of ranking candidate features is to enable the prioritisation of the most promising candidate features given limited resources (e.g., time, compute, etc.). Observe that, for a given machine learning task, there are often non-uniform costs associated with capturing and evaluating candidate features (referred to generally as evaluation costs). In particular, the closeness of the retrieved relationship between the candidate features and the target/existing features will vary.

The evaluation cost can be split into a feature capture cost and a feature evaluation cost. The feature capture cost defines the cost(s) associated with capturing, collecting, storing, cleaning, and otherwise preparing a feature for use in a machine learning model. The feature evaluation cost defines the cost(s) associated with evaluating the usefulness of a respective feature (e.g., by what degree does the feature help in minimizing loss in the learning task, etc.). In some embodiments, one or more cost models may need to be built, each including the feature, and an evaluation may need to be performed to investigate if each respective feature improves one or more chosen metrics for a machine learning task. Notably, in some embodiments, the evaluation cost does not vary significantly per feature, and consequently, differences in the feature capture cost between features dominates the feature rankings.

In some embodiments, feature capture costs can be estimated based on a variety of predetermined factors, such as, for example, whether the feature is already available in an accessible data lake (or, for a data lake that is not currently accessible, the associated access cost) and whether capturing the respective feature capture is solely a software process (or alternatively, is additional hardware required, such as the installation of additional sensors). The number and variety of factors is not meant to be particular limited.

In some embodiments, feature capture costs can be estimated in whole or in part based on tracked historical capture costs for a plurality of existing features. In some embodiments, feature capture costs for a candidate feature can be estimated using a similarity and tracked historical capture costs. For example, an estimated candidate feature cost can be a weighted function of the known costs of two or more existing features (weighted based on similarity to the candidate). In some embodiments, the feature mapping can be based on textual descriptions and/or semantic mappings, as discussed previously. In some embodiments, a cost model is trained to estimate feature capture costs from historical data.

In some embodiments, feature capture costs can be estimated by searching historical work orders for existing features. This framework is particularly useful in a predictive maintenance setting.

In some embodiments, the identifiers from the formula stores 304 are ranked based on cost and one or more other non-cost factors, such as, predicted efficacy. In other words, candidates can be ranked based on how likely a respective candidate feature is going to be useful for the augmented machine learning problem 218. In some embodiments, the strength of the extracted relationship between a candidate feature and the prediction target 210 is used as a proxy for the likelihood of the respective candidate feature being useful for predicting the prediction target 210. In some embodiments, a distance measure (e.g., Jaccard similarity, cosine similarity, Euclidean distance, etc.) of a candidate to one or more features in the feature set 208 is used as a proxy for usefulness. For example, a candidate having a high average distance to the existing features in the feature set 208 can be selected to diversify the feature set 208. In another example, a candidate having a low distance to a target in the feature set 208 can be selected as a proxy for predicted efficacy. The distance measurements can be referred to generally as closeness scores.

An example scenario is presented for illustrative purposes: first, consider a formula graph 306 having a first node at a distance of “1” from a target node, and a second node at a distance of “3” from the target node. In some embodiments, the candidate feature associated with the first node would be considered to have a stronger relationship than the second node. Consider further that, within the formula index 212, an identifier with a smaller cosine distance to the target would be considered to have a stronger relationship to the target than the feature associated with the first node.

In some embodiments, for each candidate feature, the candidate ranking module 404 can generate an overall score by dividing its respective closeness score by its respective capture cost. In some embodiments, the candidate ranking module 404 is configured to rank a plurality of candidates using each candidate's respective score. Advantageously, ranking candidates in this manner allows an end user (e.g., a modeler) to select the best features while staying within any arbitrary allocated budget.

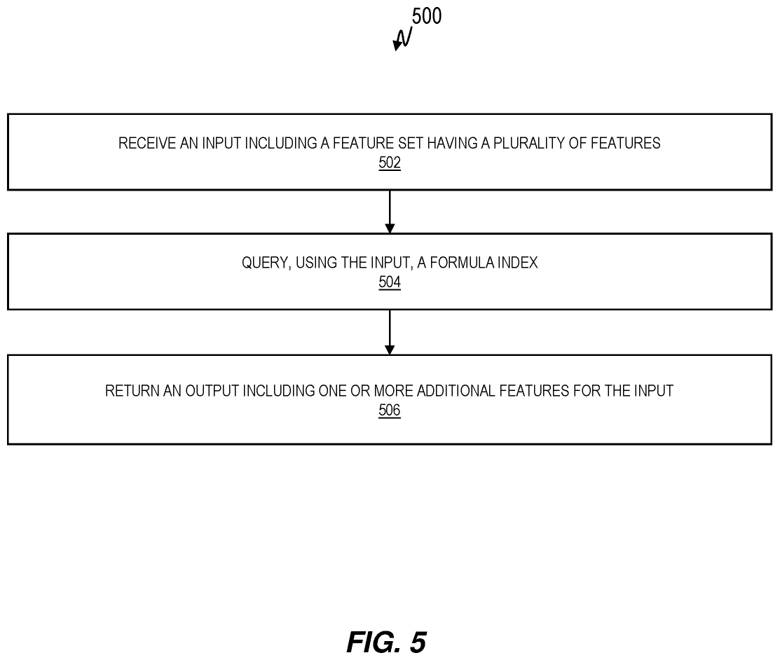

Referring now to FIG. 5, a flowchart 500 for augmenting a feature set with additional raw data is generally shown according to an embodiment. The flowchart 500 is described in reference to FIGS. 1-4 and may include additional blocks not depicted in FIG. 5. Although depicted in a particular order, the blocks depicted in FIG. 5 can be rearranged, subdivided, and/or combined.

At block 502, an input is received. In some embodiments, the input includes a feature set for a machine learning problem. In some embodiments, the feature set includes a plurality of features. In some embodiments, the input includes one of a textual description and a semantic mapping for a feature in the plurality of features. In some embodiments, the input further includes a prediction target.

At block 504, a formula index is queried using the input. In some embodiments, the formula index includes a plurality of formulas and a plurality of identifiers. In some embodiments, one or more identifiers are mapped in the formula index to each respective formula of the plurality of formulas. In some embodiments, the formula index is populated with formulas manually, programmatically, or programmatically with human supervision.

In some embodiments, querying the formula index includes matching an existing feature in the plurality of features with an identifier in the formula index and returning another identifier for an additional feature in the formula index that shares a formula with the existing feature.

At block 506, responsive to the querying, an output is returned. In some embodiments, the output includes one or more additional features for the input. In some embodiments, the one or more additional features are not found in the feature set.

In some embodiments, the method includes ranking a plurality of additional features based at least on a feature capture cost for each respective additional feature. In some embodiments, a feature capture cost defines a cost associated with capturing, collecting, storing, cleaning, or otherwise preparing the respective additional feature for use in a machine learning problem.

In some embodiments, the method includes generating a formula graph (refer to FIG. 6). In some embodiments, the formula graph includes a plurality of nodes and one or more edges. In some embodiments, each node of the plurality of nodes denotes an element in a formula of the plurality of formulas. In some embodiments, an edge connects two respective nodes of the plurality of nodes when their respective elements occur in a same formula.

FIG. 6 depicts a formula graph 306 constructed in accordance with one or more embodiments of the present invention. In some embodiments, the formula graph 306 includes a plurality of nodes 602 (here, the nodes 602a, 602b, 602c, 602d, and 602e). In some embodiments, the formula graph 306 includes one or more edges 604 connecting respective pairs of the nodes 602. The number of nodes 602 and edges 604 are not meant to be particularly limited, and are shown for illustrative purposes. It should be understood that the formula graph 306 can include any number of nodes 602 and edges 604 and all such configurations are within the contemplated scope of this disclosure.

In some embodiments, each of the nodes 602 denotes an element of a formula. For example, given the two formulas (1) F=m*a and (2) KE=½ m*v², where “F” is force, “m” is mass, “a” is acceleration, “KE” is kinetic energy, and “v” is velocity, the nodes 602 can include the nodes 602a (force node), 602b (acceleration node), 602c (mass node), 602d (kinetic energy node), and 602e (velocity node). In some embodiments, an edge 604 is constructed between two of the nodes 602 if, and only if, the respective elements co-occur in at least one formula. Continuing from the previous example with the formulas (1) and (2), an edge 604 will be constructed between the following pairs: 602a-602b, 602a-602c, 602b-602c, 602c-602d, 602c-602e, and 602d-602e.

Observe from the formula graph 306 shown in FIG. 6 that the mass node 602c is common to both formulas, and consequently, the mass node 602c serves to connect the nodes 602 of formula (1) to the nodes 602 formula (2). In other words, a path exists between the nodes 602 of formula (1) and the nodes 602 of formula (2). In this manner, formula elements which are not directly found in a same formula can nevertheless be related in terms of distance on the formula graph 306. In some embodiments, the distance between two respective nodes 602 can be used to infer a relatedness quality between the respective elements.

Technical advantages and benefits include the identification and capture of additional raw data for a respective machine learning problem. Advantageously, unlike automated feature engineering, the raw data discovered according to one or more embodiments is not limited to mere mathematical combinations of existing features. Such an approach natively improves the breadth and quality of the training data, and ultimately, the quality of the underlying machine learning model.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of #8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving an input comprising a feature set, the feature set comprising a plurality of features;
querying, using the input, a formula index, the formula index comprising a plurality of formulas and a plurality of identifiers, wherein one or more identifiers are mapped in the formula index to each respective formula of the plurality of formulas; and
responsive to the querying, returning an output comprising one or more additional features for the input.

2. The computer-implemented method of claim 1, wherein the input comprises one of a textual description and a semantic mapping for a feature in the plurality of features, and wherein the input further comprises a prediction target.

3. The computer-implemented method of claim 1, further comprising generating a formula graph comprising a plurality of nodes and one or more edges, wherein each node of the plurality of nodes denotes an element in a formula of the plurality of formulas and an edge connects two respective nodes of the plurality of nodes when their respective elements occur in a same formula.

4. The computer-implemented method of claim 1, wherein the formula index is populated with formulas manually, programmatically, or programmatically with human supervision.

5. The computer-implemented method of claim 1, wherein the one or more additional features are not found in the feature set.

6. The computer-implemented method of claim 1, wherein querying the formula index comprises matching an existing feature in the plurality of features with an identifier in the formula index and returning another identifier for an additional feature in the formula index that shares a formula with the existing feature.

7. The computer-implemented method of claim 1, further comprising ranking a plurality of additional features based at least on a feature capture cost for each respective additional feature, wherein a feature capture cost defines a cost associated with capturing, collecting, storing, cleaning, or otherwise preparing the respective additional feature for use in a machine learning problem.

8. A system having a memory, computer readable instructions, and one or more processors for executing the computer readable instructions, the computer readable instructions controlling the one or more processors to perform operations comprising:
receiving an input comprising a feature set, the feature set comprising a plurality of features;
querying, using the input, a formula index, the formula index comprising a plurality of formulas and a plurality of identifiers, wherein one or more identifiers are mapped in the formula index to each respective formula of the plurality of formulas; and
responsive to the querying, returning an output comprising one or more additional features for the input.

9. The system of claim 8, wherein the input comprises one of a textual description and a semantic mapping for a feature in the plurality of features, and wherein the input further comprises a prediction target.

10. The system of claim 8, further comprising generating a formula graph comprising a plurality of nodes and one or more edges, wherein each node of the plurality of nodes denotes an element in a formula of the plurality of formulas and an edge connects two respective nodes of the plurality of nodes when their respective elements occur in a same formula.

11. The system of claim 8, wherein the formula index is populated with formulas manually, programmatically, or programmatically with human supervision.

12. The system of claim 8, wherein the one or more additional features are not found in the feature set.

13. The system of claim 8, wherein querying the formula index comprises matching an existing feature in the plurality of features with an identifier in the formula index and returning another identifier for an additional feature in the formula index that shares a formula with the existing feature.

14. The system of claim 8, further comprising ranking a plurality of additional features based at least on a feature capture cost for each respective additional feature, wherein a feature capture cost defines a cost associated with capturing, collecting, storing, cleaning, or otherwise preparing the respective additional feature for use in a machine learning problem.

15. A computer program product comprising a computer readable storage medium having program instructions embodied therewith, the program instructions executable by one or more processors to cause the one or more processors to perform operations comprising:
receiving an input comprising a feature set, the feature set comprising a plurality of features;
querying, using the input, a formula index, the formula index comprising a plurality of formulas and a plurality of identifiers, wherein one or more identifiers are mapped in the formula index to each respective formula of the plurality of formulas; and
responsive to the querying, returning an output comprising one or more additional features for the input.

16. The computer program product of claim 15, wherein the input comprises one of a textual description and a semantic mapping for a feature in the plurality of features, and wherein the input further comprises a prediction target.

17. The computer program product of claim 15, further comprising generating a formula graph comprising a plurality of nodes and one or more edges, wherein each node of the plurality of nodes denotes an element in a formula of the plurality of formulas and an edge connects two respective nodes of the plurality of nodes when their respective elements occur in a same formula.

18. The computer program product of claim 15, wherein the formula index is populated with formulas manually, programmatically, or programmatically with human supervision.

19. The computer program product of claim 15, wherein the one or more additional features are not found in the feature set.

20. The computer program product of claim 15, wherein querying the formula index comprises matching an existing feature in the plurality of features with an identifier in the formula index and returning another identifier for an additional feature in the formula index that shares a formula with the existing feature.
